(19) United States
(12) Patent Application Publication
(10) Pub. No.: US 2024/0424563 A1
(43) Pub. Date: Dec. 26, 2024

(54) CAMERA CALIBRATION IN ADDITIVE MANUFACTURING USING LASING ON PLATE

(71) Applicant: VulcanForms Inc., Burlington, MA (US)

(72) Inventors: Yiqun Xue, Belmont, MA (US); Nicholas T. Dee, Cambridge, MA (US); Dayu Huang, Belmont, MA (US)

(73) Assignee: VulcanForms Inc., Burlington, MA (US)

(21) Appl. No.: 18/746,481

(22) Filed: Jun. 18, 2024

Related U.S. Application Data
(63) Continuation of application No. 63/522,288, filed on Jun. 21, 2023.

(51) Int. Cl. B22F 10/31; B22F 12/41; B22F 12/49; B22F 12/90; B33Y 30/00; B33Y 50/02

(52) U.S. Cl. CPC B22F 10/31; B22F 12/41; B22F 12/49; B22F 12/90; B33Y 30/00; B33Y 50/02

(57) ABSTRACT

Systems and methods involved in additive manufacturing are disclosed. Calibrating one or more optical cameras of an additive manufacturing system includes controlling one or more laser energy sources to form a design on a surface. The design is a two-dimensional array of elements, at least two elements of the array differing in shape and/or orientation from each other. The method also includes obtaining one or more images of the design based on using the one or more cameras, and analyzing the one or more images by implementing one or more algorithms to determine or update parameters for each of the one or more cameras. The parameters of each of the one or more cameras include extrinsic parameters relating a printer coordinate system of the one or more laser energy sources and an image coordinate system of the camera, intrinsic parameters controlling image distortion resulting from lens properties, or both.

### RELATED APPLICATION

This application claims priority under 35 U.S.C. § 119(e) to U.S. Provisional Application No. 63/522,288, filed Jun. 21, 2023, the content of which is incorporated by reference in its entirety for all purposes.

### FIELD

Disclosed embodiments are generally related to camera calibration in additive manufacturing using lasing on a plate.

### BACKGROUND

Additive manufacturing systems employ various techniques to create three-dimensional objects from two-dimensional layers. After a layer of precursor material is deposited onto a build surface, a portion of the layer may be fused through exposure to one or more energy sources (e.g., lasers) to create a desired two-dimensional geometry of solidified material within the layer. Next, the build surface may be indexed, and another layer of precursor material may be deposited. For example, in conventional systems, the build surface may be indexed downwardly by a distance corresponding to a thickness of a layer. This process may be repeated layer-by-layer to fuse many two-dimensional layers into a three-dimensional object. One or more cameras, referred to as weld cameras for example, may be used to image thermal emissions caused by the energy sources to monitor weld quality (e.g., how well the layers are fused). One or more other cameras may be used to image the build surface during the iterative build process to monitor the accuracy and quality of the build. Proper calibration of these cameras ensures that the information provided by their images is correct.

### SUMMARY

According to some aspects, a method of calibrating one or more optical cameras of an additive manufacturing system includes controlling one or more laser energy sources of the additive manufacturing system to form a design on a surface by directing laser energy from the one or more laser energy sources toward the surface. The design is a two-dimensional array of elements, at least two elements of the array of elements differing in shape and/or orientation from each other. The method also includes obtaining one or more images of the design based on using the one or more cameras, and analyzing the one or more images by implementing one or more algorithms to determine or update parameters for each of the one or more cameras. The parameters of each of the one or more cameras include extrinsic parameters relating a printer coordinate system of the one or more laser energy sources and an image coordinate system of the camera, intrinsic parameters controlling image distortion resulting from lens properties, or both.

According to other aspects, an additive manufacturing system includes a build surface, one or more laser energy sources, an optics assembly to output laser energy from the one or more laser energy sources toward the build surface, one or more cameras with a field of view including at least a portion of the build surface, and one or more controllers to control the one or more laser energy sources and the optics assembly to form a design on the build surface. The design is a two-dimensional array of elements, at least two elements of the array of elements differing in shape or orientation from each other, and the one or more controllers are configured to analyze one or more images, obtained based on the one or more cameras, by implementing one or more algorithms to determine or update parameters for each of the one or more cameras, the parameters of each of the one or more cameras including extrinsic parameters relating a printer coordinate system of the one or more laser energy sources and an image coordinate system of the camera, intrinsic parameters controlling image distortion resulting from lens properties, or both.

According to still other aspects, a non-transitory computer-readable medium stores instructions that, when processed by one or more processors, cause the one or more processors to implement a method for additive manufacturing. The method includes controlling one or more laser energy sources of the additive manufacturing system to form a design on a build surface by directing laser energy from the one or more laser energy sources toward the surface. The design is a two-dimensional array of elements, at least two elements of the array of elements differing in shape and/or orientation from each other. The method also includes obtaining one or more images of the design based on using the one or more cameras. The one or more images are analyzed by implementing one or more algorithms to determine or update parameters for each of the one or more cameras. The parameters of each of the one or more cameras include extrinsic parameters relating a printer coordinate system of the one or more laser energy sources and an image coordinate system of the camera, intrinsic parameters controlling image distortion resulting from lens properties, or both.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

Other advantages and novel features of the present disclosure will become apparent from the following detailed description of various non-limiting embodiments of the disclosure when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows a schematic representation of an additive manufacturing system according to some embodiments;

FIG. 2 shows the optical paths present in an additive manufacturing system according to some embodiments;

FIG. 3 shows an additive manufacturing system according to some embodiments;

FIG. 4 shows a lighting arrangement for a build surface according to some embodiments;

FIG. 5 shows an exemplary design created by using laser energy according to some embodiments;

FIG. 6 shows an exemplary design created in consideration of limitations on the placement of elements on the surface according to some embodiments;

FIG. 7A illustrates misalignment between a printer coordinate system and an image coordinate system that is addressed by calibration according to some embodiments;

FIG. 7B illustrates image distortion that is addressed by calibration according to some embodiments;

FIG. 8 illustrates a process flow of obtaining images according to an exemplary embodiment; and

FIG. 9 is a process flow of a method for additive manufacturing including calibrating one or more layer-wise cameras according to some embodiments.

### DETAILED DESCRIPTION

Additive manufacturing systems generally build up a three-dimensional object, one layer at a time. Each successive layer bonds to a preceding layer of melted or partially melted material. The melting is accomplished by energy sources such as laser energy sources that convey light energy that is directed to the material via optical fibers. More specifically, a build plan specifies locations in a printer coordinate system at which light energy should be directed. These locations in the printer coordinate system correspond to locations on the build surface. Thus, a misalignment between the printer coordinate system and the build surface will cause the build plan to specify incorrect locations on the build surface at which to direct the light energy. Such a misalignment may occur over the course of a build based on vibration and other forces or on malfunction of one or more laser energy sources or aspects of the optics assembly that directs the laser energy onto the build surface, for example. If the build continues without the misalignment being addressed or with the misalignment worsening, the end product of the additive manufacturing process may not meet desired specifications. Other defects that may occur during a build (e.g., in the powder or weld line) may also negatively affect the end product.

A camera (e.g., which may be referred to as a layer-wise camera in some embodiments) may be used to detect defects during the build or a misalignment between the printer coordinate system and the build surface. After laser energy is directed to the build surface to build each layer, one or more layer-wise cameras may obtain one or more images of the build surface. The locations indicated by the build plan in the printer coordinate system may be compared with actual locations on the build surface via the images. However, such a comparison requires an accurate homography between the printer coordinate system and the image coordinate system associated with the one or more layer-wise cameras. Generally, a homography is a type of transformation that relates two images of the same surface. In the present application, the build plan-based pattern in the printer coordinate system may be regarded as one image and the camera-obtained image may be regarded as the second image such that a homography relates the two. A homography may be represented as a homography matrix that facilitates transforming one coordinate space (e.g., printer coordinate space) to another (e.g., camera coordinate space) in order to assess alignment of the two. Based on the homography matrix, a determination can be made of whether a particular location (e.g., where a particular feature is printed) according to the build plan in the printer coordinate system actually matches a corresponding location (of that feature) in the image coordinate system. In addition, calibration to account for inherent aberrations in the camera system such as lens distortion may also be performed to facilitate monitoring the build quality with the layer-wise camera images.

Obtaining or updating the homography matrix is part of the calibration process for the layer-wise cameras and may be regarded as determining extrinsic parameters (e.g., translation, rotation, generally, position-related aspects). Addressing lens distortion may also be part of the camera calibration process and may be regarded as determining intrinsic parameters (e.g., focal length, lens distortion coefficients, generally, lens-related aspects). Conventional approaches to camera calibration have handled the intrinsic and extrinsic aspects separately. For example, a checkerboard pattern is typically imaged to determine distortion coefficients. A prepatterned plate may be expensive and, even when placed in a known precise location, may prove ineffective in matching camera image coordinates to laser energy source positions because there may be errors in positioning the laser energy sources relative to the prepatterned plate. And, scoring a surface using a laser, with a pattern of squares for example, and determining the lased location in printer coordinates may be used to obtain extrinsic parameters.

In view of the above, the inventors have recognized and appreciated the benefits of using a lased pattern to address both intrinsic and extrinsic aspects of calibration. According to various embodiments, both intrinsic and extrinsic parameters may be updated. Alternately, intrinsic parameters may be assumed to be unchanged while only extrinsic parameters are updated, or vice versa. For example, by lasing a pattern directly into a build surface that includes a layer of unfused material deposited on an underlying build plate, it may be possible to accurately calibrate the coordinate systems of the laser energy sources and associated optics assembly with that of the cameras capturing the lased pattern. According to alternate embodiments, the pattern may be lased on a different surface (e.g., on a separate plate on the build plate, on the build plate itself). In any case, a pattern that is amenable to being lased with high accuracy may be lased on the surface, such as the build surface. The pattern may include elements that differ in shape and/or orientation. The elements may be such that a collection of elements (e.g., in an image) in a given area of the surface would differ from a collection of elements in any other area of the surface. That is, the area of the surface being imaged may be identifiable based on a collection of elements in the area. The lasing direction may account for a direction from which light is directed at the surface, in some embodiments, to facilitate imaging of the resulting patterns. For example, if light is focused on the surface from two directions, referred to as lighting directions, the pattern may be lased twice in directions that are perpendicular to the two lighting directions. Without wishing to be bound by theory, by lighting a resulting weld from a direction that is at least perpendicular to the direction in which the weld extends may result in a larger shadow being cast from the weld. This contrast may help in both visualizing and identifying the locations of the welds in the images used in any of the embodiments disclosed herein. To minimize background noise and intensity variance, in some embodiments, an image taken prior to lasing (a pre-scan image) may be subtracted from an image taken after the lasing (post-scan image) in order to perform calibration of the intrinsic and extrinsic aspects.

Laser energy directed on a build surface forms at least one laser energy spot (i.e., a pixel) on the build surface. In some embodiments, incident laser spots on a build surface may be arranged in a line with a long dimension and a short dimension, or in an array. In either case, according to some aspects, a line, or array, of incident laser energy consists of multiple individual laser energy pixels arranged adjacent to each other that can have their respective power levels individually controlled. Each laser energy pixel may be turned on or turned off independently and the power of each pixel can be independently controlled. The resulting pixel-based line or array may then be scanned across a build surface to form a desired pattern thereon by controlling the individual pixels during translation of the optics assembly.

Depending on the particular embodiment, an additive manufacturing system according to the current disclosure may include any suitable number of laser energy sources. For example, in some embodiments, the number of laser energy sources may be at least 5, at least 10, at least 50, at least 100, at least 500, at least 1,000, at least 1,500, or more. In some embodiments, the number of laser energy sources may be less than 2,000, less than 1,500, less than 1,000, less than 500, less than 100, less than 50, or less than 10. Additionally, combinations of the above-noted ranges may be suitable. Ranges both greater and less than those noted above are also contemplated as the disclosure is not so limited.

Additionally, in some embodiments, a power output of a laser energy source (e.g., a laser energy source of a plurality of laser energy sources) may be between about 50 W and about 2,000 W (2 kW). For example, the power output for each laser energy source may be between about 100 W and about 1.5 kW, and/or between about 500 W and about 1 kW. Moreover, a total power output of the plurality of laser energy sources may be between about 500 W (0.5 kW) and about 4,000 kW. For example, the total power output may be between about 1 kW and about 2,000 kW, and/or between about 100 kW and about 1,000 kW. Ranges both greater and less than those noted above are also contemplated as the disclosure is not so limited.

Depending on the embodiment, an array of laser energy pixels (e.g., a line array or a two-dimensional array) may have a uniform power density along one or more axes of the array including, for example, along the length dimension (i.e. the longer dimension) of a line array. In other instances, an array can have a non-uniform power density along either of the axes of the array by setting different power output levels for each pixel's associated laser energy source. Moreover, individual pixels on the exterior portions of the array can be selectively turned off or on to produce an array with a shorter length and/or width. In some embodiments, the power levels of the various pixels in an array of laser energy may be independently controlled throughout an additive manufacturing process. For example, the various pixels may be selectively turned off, on, or operated at an intermediate power level to provide a desired power density within different portions of the array. According to some embodiments, lasing a pattern used to calibrate one or more cameras may not require an array of laser energy pixels. A single laser energy source or multiple laser energy sources operating independently (rather than as an array) may be used.

Generally, laser energy produced by a laser energy source has a power area density. In some embodiments, the power area density of the laser energy transmitted through an optical fiber is greater than or equal to 0.1 W/micrometer², greater than or equal to 0.2 W/micrometer², greater than or equal to 0.5 W/micrometer², greater than or equal to 1 W/micrometer², greater than or equal to 1.5 W/micrometer², greater than or equal to 2 W/micrometer², or greater. In some embodiments, the power area density of the laser energy transmitted through the optical fiber is less than or equal to 3 W/micrometer², less than or equal to 2 W/micrometer², less than or equal to 1.5 W/micrometer², less than or equal to 1 W/micrometer², less than or equal to 0.5 W/micrometer², less than or equal to 0.2 W/micrometer², or less. Combinations of these ranges are possible. For example, in some embodiments, the power area density of the laser energy transmitted through the optical fiber is greater than or equal to 0.1 W/micrometer² and less than or equal to 3 W/micrometer².

Depending on the application, output of the optics assembly may be scanned across a build surface of an additive manufacturing system in any appropriate fashion. For example, in one embodiment, one or more galvo scanners may be associated with one or more laser energy sources to scan the resulting one or more laser pixels across the build surface. Alternatively, in other embodiments, an optics assembly may include an optics head that is associated with one or more appropriate actuators configured to translate the optics head in a direction parallel to a plane of the build surface to scan the one or more laser pixels across the build surface. In either case, it should be understood that the disclosed systems and methods are not limited to any particular construction for scanning the laser energy across a build surface of the additive manufacturing system.

For the sake of clarity, transmission of laser energy through an optical fiber is described generically throughout. However, with respect to various parameters such as transverse cross-sectional area, transverse dimension, transmission area, power area density, and/or any other appropriate parameters related to a portion of an optical fiber that the laser energy is transmitted through, it should be understood that these parameters refer to either a parameter related to a bare optical fiber and/or a portion of an optical fiber that the laser energy is actively transmitted through such as an optical fiber core, or a secondary optical laser energy transmitting cladding surrounding the core. In contrast, any surrounding cladding, coatings, or other materials that do not actively transmit the laser energy may not be included in the disclosed ranges.

It will be appreciated that any embodiments of the systems, components, methods, and/or programs disclosed herein, or any portion(s) thereof, may be used to form any part suitable for production using additive manufacturing. For example, a method for additively manufacturing one or more parts may, in addition to any other method steps disclosed herein, include the steps of selectively fusing one or more portions of a plurality of layers of precursor material deposited onto the build surface to form the one or more parts. This may be performed in a sequential manner where each layer of precursor material is deposited on the build surface and selected portions of the upper most layer of precursor material is fused to form the individual layers of the one or more parts. This process may be continued until the one or more parts are fully formed.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

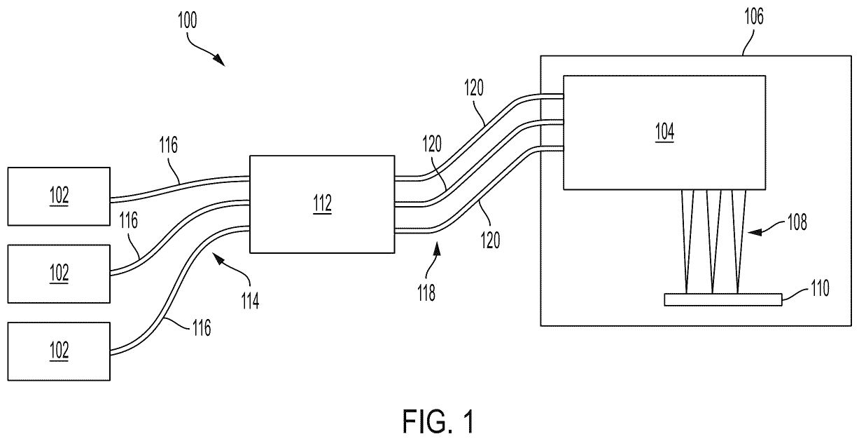

FIG. 1 shows, according to some embodiments, a schematic representation of an additive manufacturing system 100, including a plurality of laser energy sources 102 that deliver laser energy to an optics assembly 104 positioned within a machine enclosure 106. For example, the machine enclosure may define a build volume in which an additive manufacturing process may be carried out. In particular, the optics assembly may direct laser energy 108 towards a build surface 110 positioned within the machine enclosure to selectively fuse powdered material on the build surface. As described in more detail below, the optics assembly 104 may include a plurality of optics defining an optical path within the optics assembly that may transform, shape, and/or direct laser energy within the optics assembly such that the laser energy is directed onto the build surface as an array of laser energy pixels. In some embodiments, the optics assembly may be movable within machine enclosure 106 to scan laser energy 108 across build surface 110 during a manufacturing process. For example, the optics assembly may be associated with appropriate actuators, rails, motors, and/or any other appropriate structure capable of optics assembly relative to the surface. Alternatively, embodiments in which the optics assembly includes galvomirrors or other appropriate components that are configured to scan the laser energy 108 across the build surface while the optics assembly is held stationary relative to the build surface are also contemplated.

In some embodiments, the additive manufacturing system 100 further includes one or more optical fiber connectors 112 positioned between the laser energy sources 102 and the optics assembly 104. As illustrated, a first plurality of optical fibers 114 may extend between the plurality of laser energy sources 102 and the optical fiber connector 112. In particular, each laser energy source 102 may be coupled to the optical fiber connector 112 via a respective optical fiber 116 of the first plurality of optical fibers 114. Similarly, a second plurality of optical fibers 118 extends between the optical fiber connector 112 and the optics assembly 104. Each optical fiber 116 of the first plurality of optical fibers 114 is coupled to a corresponding optical fiber 120 of the second plurality of optical fibers 118 within the optical fiber connector. In this manner, laser energy from each of the laser energy sources 102 is delivered to the optics assembly 104 such that laser energy 108 can be directed onto the build surface 110 during an additive manufacturing process (i.e., a build process). Of course other methods of connecting the laser energy sources 102 due to the optics assembly 104 are also contemplated.

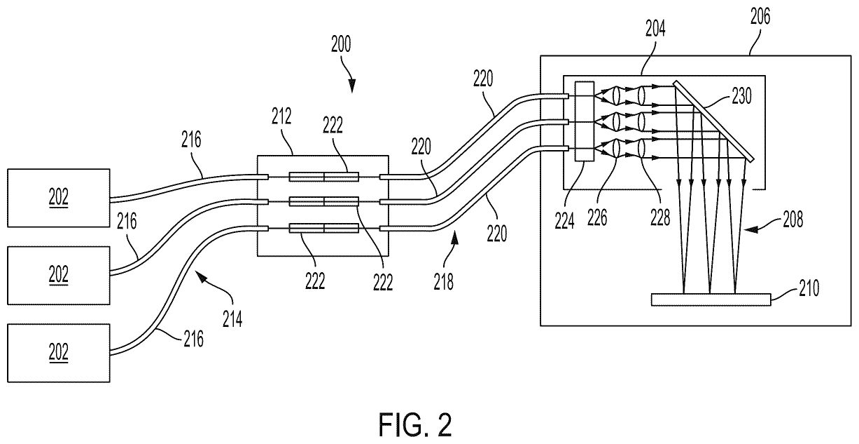

FIG. 2 shows a schematic representation of another embodiment of an additive manufacturing system 200. Similar to the embodiment discussed above in connection with FIG. 1, the additive manufacturing system 200 includes a plurality of laser energy sources 202 coupled to the optics assembly 204 within the machine enclosure 206 via the optical fiber connector 212. The first plurality of optical fibers 214 extends between the laser energy sources 202 and the optical fiber connector 212, and the second plurality of optical fibers 218 extends between the optical fiber connector 212 and optics assembly 204. In particular, each optical fiber 216 of the first plurality of optical fibers is coupled to a laser energy source 202 and corresponding optical fiber 220 of the second plurality of optical fibers 218. In the depicted embodiment, optical fibers 216 are coupled to corresponding optical fibers 220 via fusion splices 222 within the optical fiber connector 212. However, embodiments, in which the optical fibers positioned within the connector are optically coupled using other types of connections and/or single continuous optical fibers are used are also envisioned.

In the depicted embodiment, the optical fibers 220 of the second plurality of optical fibers 218 are optically coupled to an optics assembly 204 of the system. For example, an alignment fixture 224 is configured to define a desired spatial distribution of the optical fibers used to direct laser energy into the optics assembly. For example, the alignment fixture may comprise a block having a plurality of v-grooves or holes in which the optical fibers may be positioned and coupled to in order to accurately position the optical fibers within the system.

FIG. 2 also depicts exemplary optics that are optically coupled to and positioned downstream from the second plurality of optical fibers 218. The various optics included in the optics assembly may be configured to direct laser energy 208 from the second plurality of optical fibers 218 on the build surface 210 to form a desired array pattern of laser energy pixels on the build surface. For example, the optics assembly may include beam forming optics such as lenses 226 and 228 (which may be individual lenses, lens arrays, and/or combined macrolenses), mirrors 230, and/or any other appropriate type of optics disposed along the various optical paths between the optical fibers and the build surface 210 which may shape and direct the laser energy within the optics assembly. Once appropriately sized and shaped, the laser energy 208 may be directed onto the build surface 210 either through direct transmission and/or using a light directing element such as the depicted mirror 230.

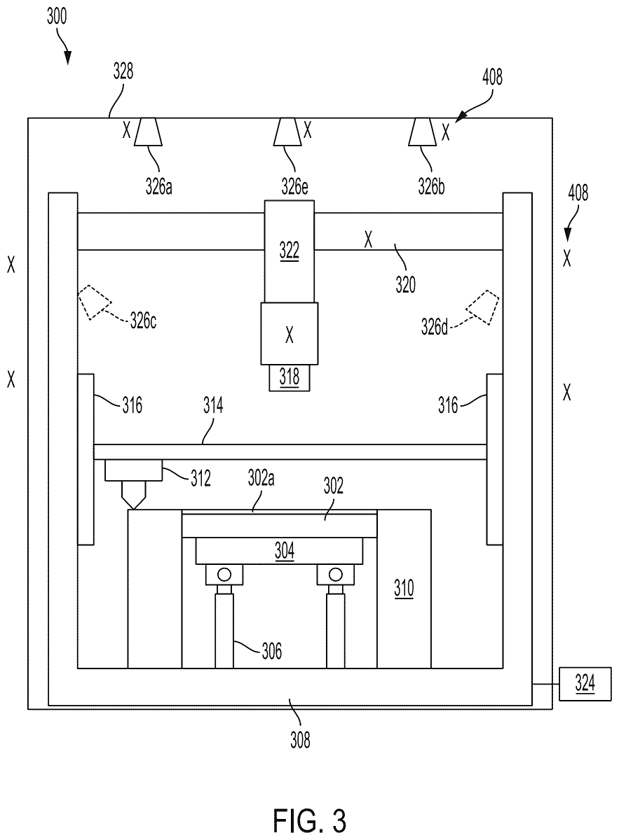

FIG. 3 depicts one embodiment of an additive manufacturing system 300 at the beginning of a build process. The additive manufacturing system 300 includes a build plate 302 mounted on a fixed plate 304, which is in turn mounted on one or more vertical supports 306 that attach to a base 308 of the additive manufacturing system 300. In the depicted embodiment, the one or more vertical supports may correspond to one, two, and/or any other appropriate number of supports configured to support the build plate, and the corresponding build surface, at a desired position and orientation. For example, the supports depicted in the figure may correspond to one or more vertical motion stages configured to control a vertical position and orientation of the build plate. A powder containment shroud 310 may at least partially, and in some embodiments completely, surround a perimeter of the build plate 302 to support a volume of precursor material 302a, such as a volume of powder, disposed on the build plate 302 and contained within the shroud. The shroud may be supported on the base 308 or by any other appropriate portion of the system.

The additive manufacturing system 300 may include a powder deposition system in the form of a recoater 312 that is mounted on a horizontal motion stage 314 that allows the recoater to be moved back and forth across either a portion, or entire, surface of the build plate 302. As the recoater traversers the build surface of the build plate, it deposits a precursor material 302a, such as a powder, onto the build plate and smooths the surface to provide a layer of precursor material with a predetermined thickness on top of the underlying volume of fused and/or unfused precursor material deposited during prior formation steps.

In some embodiments, the supports 306 of the build plate 302 may be used to index the build surface of the build plate 302 in a vertical downwards direction relative to a local direction of gravity. In such an embodiment, the recoater 312 may be held vertically stationary for dispensing precursor material 302a, such as a precursor powder, onto the exposed build surface of the build plate as the recoater is moved across the build plate each time the build plate is indexed downwards.

In some embodiments, the additive manufacturing system 300 may also include an optics assembly 318 that is supported vertically above and oriented towards the build plate 302. As detailed above, the optics assembly may be optically coupled to one or more laser energy sources, not depicted, to direct laser energy in the form or one or more laser energy pixels onto the build surface of the build plate 302. To facilitate movement of the laser energy pixels across the build surface, the optics assembly may be configured to move in one, two, or any number of directions in a plane parallel to the build surface of the build plate 302. To provide this functionality, the optics assembly may be mounted on a gantry 320, or other actuated structure, that allows the optics unit to be scanned in plane parallel to the build surface of the build plate.

In the above embodiment, the build plate is indexed vertically while the remaining active portions of the system are held vertically stationary. However, embodiments, in which the build plate is held vertically stationary and the shroud 310, recoater 312, and optics assembly 318 are indexed vertically upwards relative to a local direction of gravity during formation of successive layers are also contemplated. In such an embodiment, the recoater horizontal motion stage 314 may be supported by vertical motion stages 316 that are configured to provide vertical movement of the recoater relative to the build plate. Corresponding vertical motion stages may also be provided for the shroud 310, not depicted, to index the shroud vertically upward relative to the build plate in such an embodiment. In some embodiments, the additive manufacturing system 300 may also include an optics assembly 318 that is supported on a vertical motion stage 316 that is in turn mounted on the gantry 320 that allows the optics unit to be scanned in the plane of the build plate 302.

In the above embodiment, the vertical motion stages, horizontal motion stages, and gantry may correspond to any appropriate type of system that is configured to provide the desired vertical and/or horizontal motion. This may include supporting structures such as: rails; linear bearings, wheels, threaded shafts, and/or any other appropriate structure capable of supporting the various components during the desired movement. Movement of the components may also be provided using any appropriate type of actuator including, but not limited to, electric motors, stepper motors, hydraulic actuators, pneumatic actuators, electric actuators, and/or any other appropriate type of actuator as the disclosure is not so limited.

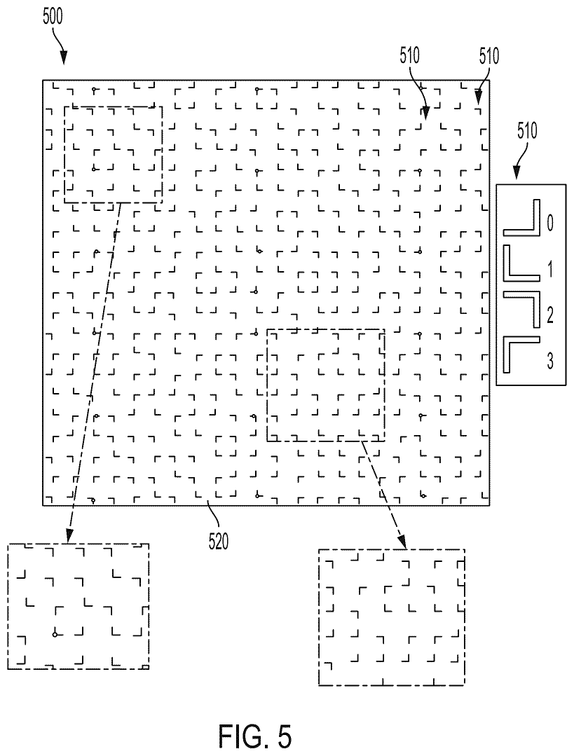

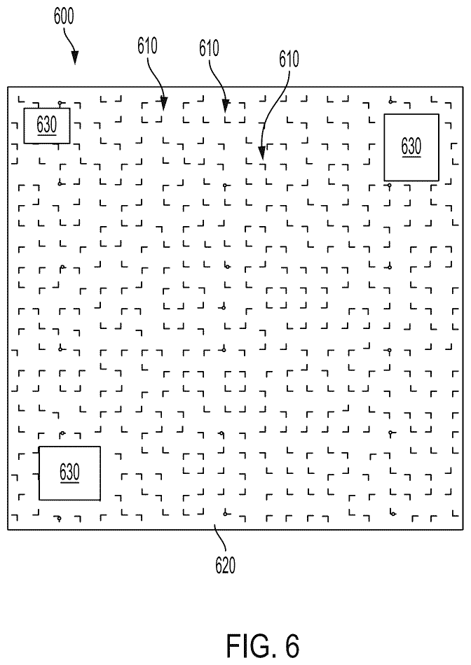

In addition to the above, in some embodiments, the depicted additive manufacturing system 300 may include one or more controllers 324 that is operatively coupled to the various actively controlled components of the additive manufacturing system 300. For example, the one or more controllers 324 may be operatively coupled to the one or more supports 306, recoater 312, optics assembly 318, the various motion stages, and/or any other appropriate component of the system. The one or more controllers 324 may create a design (e.g., as shown in FIGS. 5 and 6) and generate a build plan that is implemented by the laser energy sources 102 to lase the design on a surface. In some embodiments, one or more controllers 324 may include one or more processors and associated non-transitory computer readable memory. The non-transitory computer readable memory may include processor executable instructions that, when executed by the one or more processors, cause the additive manufacturing system to perform any of the methods disclosed herein.

As shown in FIG. 3, cameras 326a and 326b or 326c and 326d or camera 326e (any or all of which may generally be referred to as 326) may be used to image the build surface of the build plate 302 during the additive manufacturing process. That is, one, two, or more optical cameras 326 may be used as layer-wise cameras. Thus, camera, optical camera, and layer-wise camera are used interchangeably. The number of cameras 326 used may be based on a field of view of each camera 326. For example, the field of view of camera 326e may include the entire build surface of the build plate 302 such that camera 326e alone may be used as a layer-wise camera. As shown, a housing 328 or other support structure may facilitate fixed placement of one or more cameras 326.

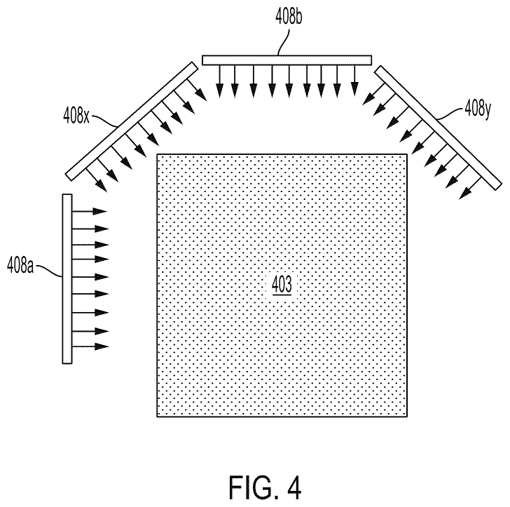

While the one or more controllers 324 are shown outside the housing 328 in the exemplary illustration of FIG. 3, one or more controllers 324 may additionally or alternately be within the housing 328. Alternately, as shown for cameras 326c and 326d, the cameras 326 may be affixed to other support structures of the additive manufacturing system 300, including the gantry 320. As indicated by the symbol “X” in FIG. 3, one or more light sources 408 may be part of the additive manufacturing system 300. The various illustrated locations are not intended to be limiting but, instead, to exemplify some of the various locations for one or more light sources 408 used in the additive manufacturing system 300. Thus, it should be understood that one or more light sources 408 may be positioned on any appropriate portion of the additive manufacturing system 300 with an appropriate location and orientation to direct light from the light source 408 to the build surface with a desired lighting orientation. The light sources 408 are further discussed with reference to FIG. 4.

As noted above, depending on the embodiment, the one or more cameras 326 may either have a fixed reference frame relative to the build surface (i.e., the one or more cameras 326 are stationary) and/or they may translate relative to the build surface (e.g., when affixed to a moving structure like gantry 320). According to embodiments in which the one or more cameras 326 translate relative to the build surface, the fields of view of the cameras 326 may be translated across the build surface in any desired pattern to permit imaging of the desired portion of the build surface for calibration purposes. It should be understood that any appropriate type of camera 326 may be used to image a build surface including, but not limited to, line cameras, two dimensional cameras with an array of pixels, and/or other appropriate types of cameras. This may include charged coupled device (CCD) cameras, complementary metal-oxide-semiconductor (CMOS) cameras, electron multiplying charge coupled device (EMCCD) cameras, and/or other appropriate types of cameras capable of imaging the build surface. Additionally, depending on the parameters to be monitored by the cameras 326, the cameras 326 may operate to image any appropriate range of wavelengths including ultraviolet (1 nm to 400 nm), visible (400 nm to 750 nm), near infrared (750 nm to 2.5 μm), infrared (2.5 μm to 25 μm), combinations of the forgoing, and/or any other appropriate range of wavelengths as the disclosed methods and systems are not limited to any particular type of camera for imaging the build surface. The resolution of the cameras 326 may be sufficient to distinguish the welds/spot size in an obtained image.

FIG. 4 shows an arrangement of light sources 408a, 408x, 408b, 408y (any or all of which may generally be referred to as 408) and a build surface 403 according to some embodiments. The light sources 408 may be referred to as edge lighting sources based on their arrangement at an edge of the surface 403. While four light sources 408 are shown in the exemplary illustration, a pair of light sources 408a and 408b or 408x and 408y, a single light source 408, or any number of light sources 408 may be used to direct light from the light source 408 to the surface 403. The direction of light from each of the light sources 408a, 408b, 408x, 408y is indicated by arrows in FIG. 4. Generally, one or more light sources 408 may be configured to direct light onto at least a portion of the surface 403. In some embodiments, the light sources 408 may be configured to emit light in a direction that is substantially parallel to the build surface 403 (e.g., a direction of primary light propagation may be substantially parallel to the build surface). That is, position of a light source 408 (relative to the surface 403) may be indicate direction of light. The light sources 408 may be located at any location and orientation around a perimeter of the surface 403 to provide light to the build surface. As shown by the exemplary positions in FIG. 3, the light sources 408 may be located at a different height relative to the surface 403.

Optionally, a plurality of light sources 408 may partially or completely surround the build surface to illuminate the build surface from multiple different directions. Thus, by selectively activating the light sources 408, the direction of light illumination on the surface 403 (i.e., lighting direction) may be controlled which may help to facilitate imaging by one or more layer-wise cameras 326 of different types of defects that may be present on a surface 403. In some embodiments, one or more photosensitive detectors may be configured to obtain one or more images of at least a portion of the surface 403 containing a recoated layer of precursor material on the surface 403. In some embodiments, the photosensitive detectors may be configured to obtain grayscale images of the surface 403. In other embodiments, colored images may be obtained using the photosensitive detectors. The scanning direction in which laser energy from one or more laser energy sources 102 is directed may be based on a direction of light from a light source 408. For example, the one or more controllers 324 may generate a build plan that specifies the scanning direction in which laser energy is directed to be perpendicular to a direction of light from one or more edge lighting sources 408. In some embodiments, the build plan includes commands (e.g., directions, instructions) to control the one or more laser energy sources 102.

FIG. 5 shows an exemplary design 500 created by directing laser energy at a (build) surface 520 to melt at least a portion of a layer of material disposed on the surface according to some embodiments. As previously noted, lasing may be performed directly on the build plate or on a separate plate placed on the build plate in alternate embodiments. As further discussed, this design 500 may be imaged by one or more cameras 326 as part of the calibration process. As previously noted, the design 500 may be created by the one or more controllers 324 and may result from a build plan generated by the one or more controllers 324 to control the laser energy sources 102. The design 500 is a two-dimensional array of elements 510. Creating the design may include one or more controllers 324 selecting from among two or more template designs. As further discussed, the design 500 may be analyzed to ensure that the pattern of elements 510 is sufficiently randomized.

As indicated, the exemplary design 500 shown in FIG. 5 is made up of four elements 510, numbered 0, 1, 2, and 3, that are randomly distributed over the two-dimensional array of the design 500. These elements 510 can be regarded as different orientations of the same shape or as different shapes. As FIG. 5 indicates, not only does the shape and/or orientation of the elements 510 differ within the design but, also, the pattern of differently shaped and/or oriented elements 510 is non-repeating. As a result, as the expanded areas of the design 500 illustrate, no two areas of the design 500 have the same pattern of elements 510. This facilitates using a pattern of elements 510 to identify a particular area of the design 500 associated with the pattern. While four specific elements 510 that differ in shape and/or orientation from each other are shown to make up the design 500 in FIG. 5, alternate designs 500 that include elements 510 of different shapes and/or orientations than those shown in FIG. 5 are not limited by the example.

The shapes and layout may be any shapes or layout that facilitate the location within the overall pattern to be identified. The shapes and layout may be randomly generated or predetermined (e.g., selected from a set of templates). Portions of the build surface, within a predetermined size and/or area, may have a unique pattern that is not repeated on the lased build surface. Prior to lasing, the pattern of elements 510 considered for a build plan may be analyzed to ensure that, even if some portion of the elements 510 are occluded, the different areas are still distinguishable. The desired level of tolerance to occlusion may dictate the level of randomization required for the pattern of elements 510. The desired level of tolerance may refer to a number of elements 510 that may be occluded or a size of an area of the design 500 that may be occluded while still facilitating an ability to distinguish regions of the design 500.

FIG. 6 shows an exemplary design 600 created in consideration of limitations on the placement of elements 610 on the surface 620 according to some embodiments. In some cases, for example, one or more areas of the surface 620 may include an existing build that must be avoided when lasing a design 600 to be used for calibration of one or more cameras 326. These areas may be regarded as masked areas 630 by the one or more controllers 324 in creating the design 600. While the one or more controllers 324 avoid creating a design 600 with any elements 610 in the masked areas 630, the one or more controllers 324 may also create a design 600 with elements 610 that otherwise cover as much of the surface 620 as possible, as illustrated in FIG. 6.

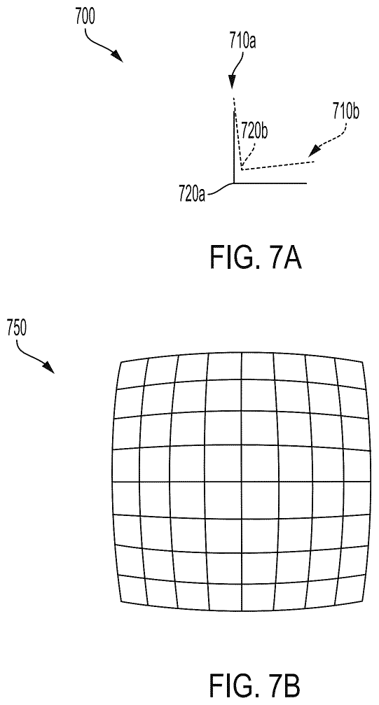

FIGS. 7A and 7B illustrate aspects of the calibration of one or more cameras 326 according to some embodiments. FIG. 7A illustrates misalignment between a printer coordinate system of the laser energy sources 102 and an image coordinate system of a given camera 326. Calibration of extrinsic parameters may address the exemplary misalignment according to exemplary embodiments. FIG. 7B illustrates exemplary distortion. Specifically, FIG. 7B shows a distorted image of a two-dimensional array of straight lines. Calibration of intrinsic parameters may address the exemplary distortion according to exemplary embodiments. As previously noted, calibration may be used to update both extrinsic and intrinsic parameters (to address alignment and distortion) together. Alternately, one set of parameters (e.g., intrinsic parameters) may be assumed to be unchanged while only the other set of parameters (e.g., extrinsic parameters) is updated as part of the calibration process.

As part of the calibration process for a given camera 326, a design 700 lased on a surface may be imaged by the given camera 326. An element 710a in the printer coordinate system and the same element 710b in the image coordinate system are shown in FIG. 7A. A feature 720a (e.g., a corner) in the printer coordinate system and the same feature 720b in the image coordinate system are also indicated. The one or more controllers 324 may determine or update the homography matrix that indicates any rotation and/or translation needed to match up the elements 710a and 710b and, more specifically, the features 720a and 720b. For example, four or more sets of features 720a and 720b within the design 700 may be used to determine or update the homography matrix. An algorithm may be implemented by one or more controllers 324 to determine or update the homography matrix. According to exemplary embodiments, intrinsic parameters (e.g., focal length, lens distortion) may be simultaneously updated. That is, image distortion may additionally be taken into account when creating the homography matrix. As such, the calibrated homography matrix may provide an aligned, undistorted image. The updating of parameters may be via known algorithms that are conventionally used separately to update either intrinsic or extrinsic parameters.

Once the calibration process is completed using a design 700 of elements 710, whenever the given calibrated camera 326 takes an image of the surface, the homography matrix may then be used to provide an undistorted image that is translated to match the printer coordinate system. Any build detects (e.g., powder defects, weld line defects) may be detected by using the resulting image. In addition, if the translated image does not match the build plan, this suggests an issue with the alignment of the laser energy sources 102. That is, because the cameras 326 are fixed, a mismatch, subsequent to the calibration process, between a build according to the printer coordinate system and an image of the build taken by a calibrated camera 326 that is then translated according to the homography matrix may indicate a misalignment between the printer coordinate system and implementation of the build plan on the surface.

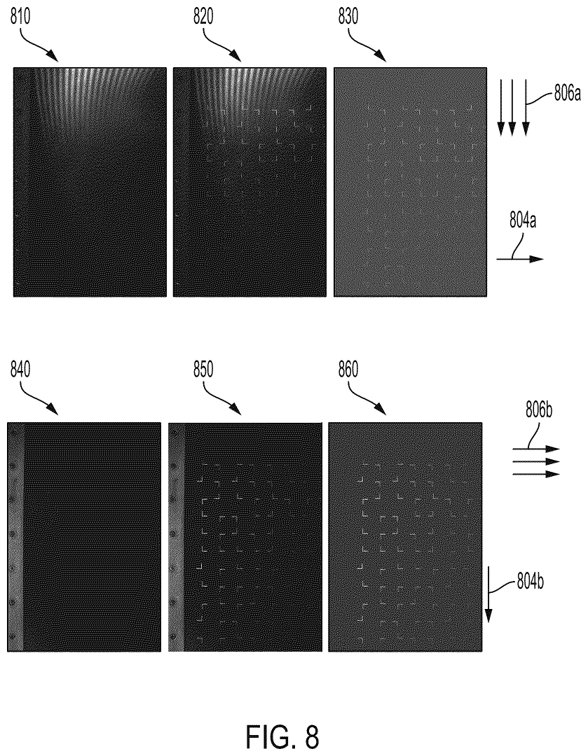

FIG. 8 illustrates a process flow of obtaining images according to an exemplary embodiment. The exemplary embodiment pertains to the case of lasing in two scan directions 804a and 804b, each of which is perpendicular to a respective lighting direction 806a, 806b. A first pre-scan image 810 is obtained prior to any lasing. A first post-scan image 820 is obtained after the first scan in performed, in scan direction 804a, with a light source 408 providing light in lighting direction 806a. The first pre-scan image 810 is subtracted from the first post-scan image 820 to obtain the first resulting image 830.

A second pre-scan image 840 is obtained. A second post-scan image 850 is then obtained after the second scan is performed, in scan direction 804b, with a light source 408 providing light in lighting direction 806b. Subtracting the second pre-scan image 840 from the second post-scan image 850 provides second resulting image 860. This second resulting image 860 may be used for calibration of the camera 326 that obtained the pre-scan and post-scan images 810, 820, 840, 850. As each of the resulting images 830, 860 indicates, subtracting pre-scan images 810, 840 from corresponding post-scan images 820, 850 may minimize background noise and image intensity variance and improve resolution to facilitate more accurate calibration.

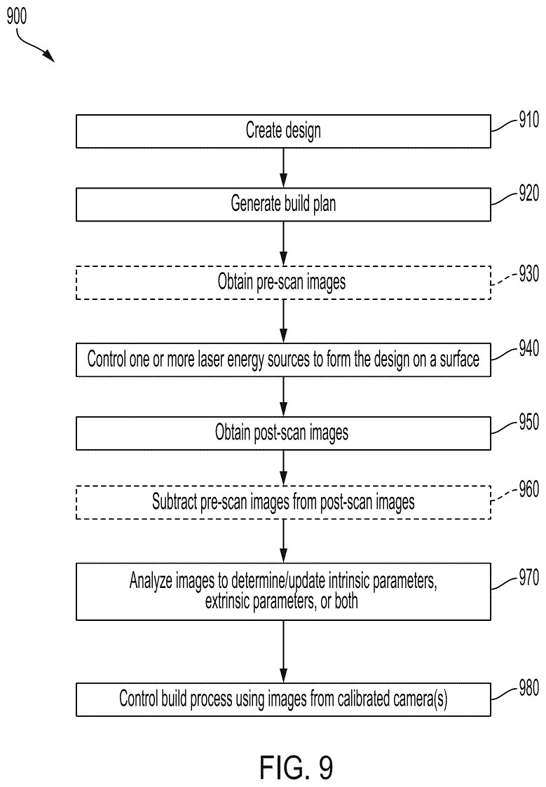

FIG. 9 is a process flow of a method 900 for additive manufacturing including calibrating one or more layer-wise cameras 326 according to some embodiments. At 910, creating a design 500, 600, 700 refers to the one or more controller 324 creating a pattern of elements 510, 610, 710 such that at least two elements 510, 610, 710 differ in shape and/or orientation. Creating the design 500, 600, 700, at 910, also includes omitting elements 510, 610, 710 from masked areas 630. Generating a build plan, at 920, refers to the one or more controllers 324 generating the instructions to control the laser energy sources 102, as well as where laser energy from one or more laser energy sources 102 is directed.

An optional process at 930, which is discussed with reference to FIG. 8, involves one or more layer-wise cameras 326 obtaining pre-scan images, which are images of a surface prior to lasing of the design 500, 600, 700 (i.e., scanning of the surface with the laser energy). At 940, controlling one or more laser energy sources 102 to form the design 500, 600, 700 on the surface refers to implementation of the build plan generated by the one or more controllers 324 (at 920). At 950, obtaining post-scan images is with one or more layer-wise cameras 326. If the optional process of obtaining pre-scan images is performed at 930 then, optionally, subtracting pre-scan images from corresponding post-scan images, at 960, may minimize background noise and image intensity variance, as noted with reference to FIG. 8. This may make it easier to detect lased areas in the images. Image intensity may also be improved based on the build plan (generated at 920) setting the lasing direction in consideration of the direction from which one or more light sources 408 light the surface.

For example, two light sources 408a and 408b directing light from orthogonal directions may be used, as shown in FIG. 4. In this case, lasing may be performed twice, each time in a direction that is perpendicular to the direction of light coming from one of the light sources 408a or 408b. That is, lasing may first be performed in an up and down direction, according to the orientation shown in FIG. 4, because it is perpendicular to the light direction from light source 408a. Lasing may then be performed in a side-to-side direction in consideration of the light direction from light source 408b.

At 970, processes include analyzing images to determine or update intrinsic parameters, extrinsic parameters, or both for one or more layer-wise cameras 326, as discussed with reference to FIGS. 7A and 7B. Once the calibration process is complete, based on processes at 970, the calibrated cameras 326 may be used to monitor and control the build process, at 980. For example, images from calibrated cameras 326 may be used to assess weld quality or properties of the melt pool, which is the main product resulting from interaction between laser energy and the material of the build surface. In addition, defect identification may be performed. This may refer, for example, to the accuracy with which the product defined by the build plan is implemented on the build surface. Using the images may begin with using a homography matrix determined for each of one or more calibrated cameras 326 to match the images obtained by the one or more calibrated cameras 326 in the camera coordinate system with the build plan in the printer coordinate system and obtain undistorted images in the printer coordinate system.

The above method may be implemented by one or more controllers including at least one processor operatively coupled to the various controllable portions of an additive manufacturing system as disclosed herein. The method may be embodied as computer readable instructions stored on non-transitory computer readable memory associated with the at least one processor such that when executed by the at least one processor the additive manufacturing system may perform any of the actions related to the methods disclosed herein. Additionally, it should be understood that the disclosed order of the steps is exemplary and that the disclosed steps may be performed in a different order, simultaneously, and/or may include one or more additional intermediate steps not shown as the disclosure is not so limited.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device including one or more processors may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A method of calibrating one or more optical cameras of an additive manufacturing system, the method comprising:
controlling one or more laser energy sources of the additive manufacturing system to form a design on a surface by directing laser energy from the one or more laser energy sources toward the surface, wherein the design is a two-dimensional array of elements, at least two elements of the array of elements differing in shape and/or orientation from each other;
obtaining one or more images of the design based on using the one or more cameras; and
analyzing the one or more images by implementing one or more algorithms to determine or update parameters for each of the one or more cameras, the parameters of each of the one or more cameras including extrinsic parameters relating a printer coordinate system of the one or more laser energy sources and an image coordinate system of the camera, intrinsic parameters controlling image distortion resulting from lens properties, or both.

2. The method according to claim 1, wherein the controlling the one or more laser energy sources includes forming the design on a build surface by directing laser energy from the one or more laser energy sources toward the build surface to melt at least a portion of a layer of material disposed on the build surface.

3. The method according to claim 1, further comprising creating the design and generating a build plan for the design, the build plan including commands to control the one or more laser energy sources.

4. The method according to claim 3, wherein the creating the design and the generating the build plan include considering a position of one or more edge lighting sources relative to the surface.

5. The method according to claim 4, wherein the generating the build plan includes setting a scanning direction in which the laser energy is directed to be perpendicular to a direction of light from one of the one or more edge lighting sources to the surface.

6. The method according to claim 3, wherein the creating the design includes selecting from among two or more template designs.

7. The method according to claim 3, wherein the creating the design includes masking areas of the surface within which the design cannot be created.

8. The method according to claim 1, wherein the one or more cameras includes two cameras, and the obtaining the one or more images includes using the two cameras with fixed positions to simultaneously capture two or more images.

9. The method according to claim 1, wherein the parameters are the extrinsic parameters.

10. The method according to claim 1, wherein the determining or updating the parameters includes detecting locations of specific features of the elements in the one or more images to compare with corresponding feature locations of the elements in the printer coordinate system.

11. The method according to claim 1, wherein the parameters are the intrinsic parameters.

12. The method according to claim 1, wherein the determining or updating the parameters includes determining distortion coefficients of the one of more cameras based on the analyzing the one or more images.

13. The method according to claim 1, further comprising obtaining one or more pre-scan images of the surface prior to the forming the design and obtaining one or more post-scan images of the surface following the forming the design, wherein the obtaining the one or more images is based on subtracting the one or more pre-scan images from the one or more post-scan images.

14. The method according to claim 1, further comprising controlling the additive manufacturing system during a build operation based on obtaining additional images using the one or more cameras following determining or updating of the parameters and identifying build defects.

15. The method according to claim 1, further comprising fusing precursor material with the one or more laser energy sources to form one or more parts on the surface.

16. A part manufactured using the method of claim 15.

17. An additive manufacturing system comprising:
a build surface;
one or more laser energy sources;
an optics assembly configured to output laser energy from the one or more laser energy sources toward the build surface;
one or more cameras with a field of view including at least a portion of the build surface; and
one or more controllers configured to control the one or more laser energy sources and the optics assembly to form a design on the build surface, wherein the design is a two-dimensional array of elements, at least two elements of the array of elements differing in shape or orientation from each other, and the one or more controllers are configured to analyze one or more images, obtained based on the one or more cameras, by implementing one or more algorithms to determine or update parameters for each of the one or more cameras, the parameters of each of the one or more cameras including extrinsic parameters relating a printer coordinate system of the one or more laser energy sources and an image coordinate system of the camera, intrinsic parameters controlling image distortion resulting from lens properties, or both.

18. The additive manufacturing system according to claim 17, wherein the one or more controllers are configured to create the design or select the design from two or more template designs and to generate a build plan for the design, the build plan including commands to control the one or more laser energy sources.

19. The additive manufacturing system according to claim 18, wherein the one or more controllers are configured to create the design and generate the build plan in consideration of a position of one or more edge lighting sources relative to the build surface or in consideration of masked areas indicating areas of the build surface in which the design cannot be formed.

20. The additive manufacturing system according to claim 17, wherein the one or more controllers are configured to determine or update the parameters by detecting locations of specific features of the elements in the one or more images to compare with corresponding feature locations of the elements in the printer coordinate system.

21. The additive manufacturing system according to claim 17, wherein the one or more controllers are configured to determine or update the parameters by determining distortion coefficients of the one of more cameras based on the analyzing the one or more images.

22. A non-transitory computer-readable medium storing instructions that, when processed by one or more processors, cause the one or more processors to implement a method for additive manufacturing, the method comprising:
controlling one or more laser energy sources of an additive manufacturing system to form a design on a build surface by directing laser energy from the one or more laser energy sources toward the surface, wherein the design is a two-dimensional array of elements, at least two elements of the array of elements differing in shape and/or orientation from each other;
obtaining one or more images of the design based on using one or more cameras; and
analyzing the one or more images by implementing one or more algorithms to determine or update parameters for each of the one or more cameras, the parameters of each of the one or more cameras including extrinsic parameters relating a printer coordinate system of the one or more laser energy sources and an image coordinate system of the camera, intrinsic parameters controlling image distortion resulting from lens properties, or both.

23. The non-transitory computer-readable medium according to claim 22, further comprising creating the design and generating a build plan for the design, the build plan including commands to control the one or more laser energy sources.

24. The non-transitory computer-readable medium according to claim 23, wherein the creating the design and generating the build plan is in consideration of a position of one or more edge lighting sources relative to the build surface or masked areas indicating areas of the build surface in which the design cannot be formed.

25. The non-transitory computer-readable medium according to claim 22, wherein determining or updating the parameters includes detecting locations of specific features of the elements in the one or more images to compare with corresponding feature locations of the elements in the printer coordinate system.

26. The non-transitory computer-readable medium according to claim 22, wherein the determining or updating the parameters includes determining distortion coefficients associated with each of the one or more cameras.
